(19) United States
(12) Patent Application Publication
(10) Pub. No.: US 2025/0076632 A1
(43) Pub. Date: Mar. 6, 2025

(54) ANTI-GLARE ACCESSORY FOR FIREARM SCOPE

(71) Applicant: 5.11, Inc., Manteca, CA (US)

(72) Inventors: Camille Marie Machado, San Clemente, CA (US); Alexander Charles Funderburk, Costa Mesa, CA (US); John Thiet Ly, Lakewood, CA (US); Wallace Haruo Sato, II, Garden Grove, CA (US)

(21) Appl. No.: 18/815,574

(22) Filed: Aug. 26, 2024

Related U.S. Application Data
(60) Provisional application No. 63/535,025, filed on Aug. 28, 2023.

(51) Int. Cl. G02B 23/16; F41G 1/38

(52) U.S. Cl. CPC G02B 23/16; F41G 1/38

(57) ABSTRACT

An anti-glare system can include a material cover comprising at least one slot. An anti-glare system can include an attachment mechanism configured to attach the material cover to a scope, wherein the material cover is less than 3 mm thick. The anti-glare system can further include a strap or elastic system to connect to a scope.

### INCORPORATION BY REFERENCE TO ANY PRIORITY APPLICATIONS

Any and all applications for which a foreign or domestic priority claim is identified in the Application Data Sheet as filed with the present application are hereby incorporated by reference herein in their entireties and made a part of the present disclosure.

### BACKGROUND

### Field of the Invention

The present disclosure generally relates to optical accessories. In particular, the present disclosure relates to a cover for a firearm scope, or similar optic, that is configured to reduce an amount of ambient light that reaches the scope or to reduce glare or reflection from the scope.

### Description of the Related Art

In the context of optics, which are usually used to enhance or magnify views, there is a need to reduce glare and/or reflection. An anti-glare system can be used to reduce glare on or light reflection from an optic. An anti-glare system can block or filter extra light to reduce glare. Existing anti-glare systems tend to be complicated, bulky, and/or reduce the effectiveness of the optic.

### SUMMARY

A need exists for an anti-glare system that is inexpensive, simple, and easy to use. Such an anti-glare system can improve upon the prior art or at least provide the public with a useful choice.

In some aspects, the disclosure relates to an anti-glare system including a material cover including a plurality of slots. An attachment mechanism is configured to attach the material cover to a scope or other optical device. A collective area of the plurality of slots is between about 16-20 percent of a total area of the material cover.

In some aspects, the disclosure relates to an anti-glare system configured for low light conditions. The anti-glare system includes a material cover including at least one slot or only one slot. An attachment mechanism is configured to attach the material cover to a scope or other optical device. A collective area of the at least one slot or the only one slot is between about 9-15 percent of a total area of the material cover.

In some aspects, the disclosure relates to an anti-glare system including a material cover including at least one slot. An attachment mechanism is configured to attach the material cover to a scope or other optical device. The material cover is less than 3 mm thick.

In some aspects, the disclosure relates to an anti-glare system including a strap configured to wrap circumferentially around a scope. The system also includes a material cover and a material cover connector. The material cover connector is configured to connect the material cover to the strap.

In some aspects, the disclosure relates to an anti-glare system including a material cover and a material cover connector. The material cover connector includes an elastic portion configured to secure the material cover connector to a scope. The material cover is configured to connect to the material cover connector.

### BRIEF DESCRIPTION OF THE DRAWINGS

These and other features, aspects and advantages of the present disclosure are described herein with reference to drawings of preferred embodiments, which are intended to illustrate, and not to limit, the present invention.

FIG. 1 is a perspective view of an embodiment of the anti-glare system assembled to an optic in the form of a firearm scope.

FIG. 2 is an enlarged view of a target side of the firearm scope with the anti-glare system of FIG. 1.

FIG. 3 is an exploded perspective view showing the individual components of the anti-glare system.

FIG. 4 is a plan view of the individual components of the anti-glare system.

FIG. 5 is a plan view of a first material cover of the anti-glare system.

FIG. 6 is a plan view of a second material cover of the anti-glare system.

FIG. 7 is a plan view of a third material cover of the anti-glare system.

FIG. 8 is a perspective view of a target side of a firearm scope with an alternative version of the anti-glare system.

### DETAILED DESCRIPTION

Anti-glare systems, which can also be anti-reflective systems or ambient light reduction systems, are used to reduce the glare on or reflection from an optic or other surface by blocking or reducing at least some portion of the environmental light from reaching a lens of the optic. Thus, the anti-glare system can reduce the glare on the optic in very bright environments to provide better visibility and/or less eye strain to a user of the optic. In addition, because it reduces the light reaching a lens of the optic, the anti-glare system also reduces the incidence of or degree of reflection of light off of the lens of the optic. Example optics may include binoculars, scopes, telescopes, or any other optic. An anti-glare system is described herein in an application for a firearm scope. However, the anti-glare system can be used with, or configured for use with, other types of optics, such as binoculars, a monocular, or other tactical optics, or can be used with other objects that require or can benefit from reduced glare or reflection, such as optical sensors or the like. Accordingly, references to scopes herein can be replaced with a reference to any different optic or other object disclosed herein.

The anti-glare system can be mounted on one or both sides of a scope. In most embodiments, the anti-glare system is mounted on a target side, objective lens side, or on the objective bell of a scope. That is, the anti-glare system is usually mounted on the distal end of the scope relative to the user or the end furthest from the user.

In some embodiments, the anti-glare system can include a material cover and a connector or an attachment mechanism. The material cover can be located on the target side of the scope and held in position by the attachment mechanism. The material cover can include at least one orifice or hole that reduces ambient or environmental light to the optic in comparison to the optic without the anti-glare system installed. In some configurations, the material cover includes a plurality of holes, which can be in the form of slots. The attachment mechanism can include a material cover connector, which can directly or indirectly connect the material cover to the optic. That is, in some configurations, the material cover connector indirectly connects the material cover to the optic via a strap. The strap can wrap around the circumference of the scope, securing the strap to the scope. The material cover connector can directly connect to the strap to secure the material cover to the scope. As such the anti-glare system can be easily applied to and removed from the scope. Individual components, such as the material cover, can be easily replaced, possibly while leaving the strap and or attachment mechanism in place.

The material cover can be shaped and sized to generally, approximately, or exactly match a particular scope or range of scope sizes. Preferably, the material cover or the material cover in combination with the attachment mechanism covers a substantial entirety of the lens of the scope that is covered by the anti-glare system with the exception of the one or more openings of the material cover. For example, the objective lens of a scope can be a 50 mm diameter. The material cover can also have a 50 mm diameter or an approximately 50 mm diameter. It should be understood that the material cover can be slightly smaller or larger than the size of the objective lens. In some configurations, a material cover of a certain size could also be used with smaller objective lens diameters. However, such a configuration will result in a different proportion of the total opening area to the area of the objective lens, which although less than ideal, may be satisfactory in some applications.

As described above, the material cover can include one or more openings. The openings can be of any suitable arrangement. In some configurations, the material cover can include a pattern of orifices, holes, or slots. The orifices, holes, or slots allow at least some portion of ambient or environmental light to reach the objective lens of the scope. The body of the material cover, which covers the lens and defines the orifices, holes, or slots, blocks at least some portion of the environmental light from reaching the objective lens of the optic. This reduction in the environmental light on the objective lens of the optic reduces the glare of the environmental light on, or reflection of the environmental light from, the objective lens of the optic, resulting in a better user experience.

In some configurations, as described herein, the orifices can be a plurality of slots or a single slot. However, as noted previously, the orifices can have other shapes. Accordingly, references to slots herein can be replaced with any other type or shape of opening disclosed herein. The slots can be a consistent height across their length or can vary, forming an oval or other alternative shapes. The plurality of slots can vary in length such that ones located at or towards the center of an optic are relatively longer and ones located near or towards an edge of the optic are relatively shorter. The change in length can be progressive with each slot that is located farther from the center of the optic being shorter in length than the previous slot located at or closer to the center of the optic. There can be a consistent gap between the plurality of slots such that they are equally spaced apart from one another, but the gap or spacing between slots could vary, if desired.

The material cover can be made of or include a relatively thin and flexible material such as the loop material portion of a hook and loop fastener. However, in other configurations, the material cover can be made of or include the hook material portion of a hook and loop fastener. In other configurations, the material cover can be an alternative fabric such as felt, tweed, cloth, or a waterproof fabric. Further, the material cover can be a rigid material such as metal, plastic, fiberglass, carbon fiber, or an alternative material or composite material. The material cover can also be a combination of materials. The material cover, outside of any orifices, can block most or all light from being transmitted through the material cover. Alternatively, the material cover may be configured to allow some light to be transmitted therethrough. The orifice(s) can be configured in view of the light transmissibility of the material cover. In some configurations, the material cover is relatively thin or at least thin in comparison to existing anti-glare devices. In some configurations, the material cover can have a thickness that is equal to or less than 4 mm, 3 mm, or 2 mm. Some existing anti-glare or anti-reflection devices utilize a plurality of relatively elongate passages, which increases the effective length of the scope or other optic to which it is mounted and causes the device itself to be relatively large. In contrast, the illustrated anti-glare or anti-reflection system utilizes a thin material cover to achieve effective results.

The attachment mechanism can comprise a strap and a material cover connector. The material cover connector can be configured to connect to the material cover and the strap independently or separately from one another. As such, the material cover connector can secure the material cover to the strap, where the strap is secured to the scope. Accordingly, the material cover connector can serve to locate the material cover in relation to the scope. The material cover could instead be directly connected to the scope. The material cover connector can connect to the strap, the scope, or the material cover via a hook and loop fastener or other suitable connector, such as clips, straps, magnets, ratchets, buckles, or any other suitable connector. In the illustrated arrangement, the material cover connector can be made of or include the hook material portion of a hook and loop fastener. However, in other embodiments, the material cover connector can be made of or include the loop material portion of a hook and loop fastener. It should also be understood that in some embodiments the material cover and the material cover connector can be formed as a single piece. However, it is preferred for at least some applications that the material cover and the material cover connector are separate to allow the material cover to be replaced or interchanged.

The strap can be made of a relatively flexible material and configured to wrap around the scope. The strap can wrap around the scope such that it is in tension and applies pressure or compression on the scope, allowing it to secure itself to the scope. Thus, preferably, the strap is relatively inelastic with limited stretch. Some stretch, however, may be desirable to facilitate tensioning of the strap so that it securely attaches to the scope. However, the simplicity of the anti-glare system allows it to be lightweight, which reduces the forces tending to separate the strap or the anti-glare system from the scope as a result of gravity or movement of the scope.

In some configurations, the strap can be made of the loop material portion of a hook and loop fastener and have a hook material portion connection tab such that it can connect to itself, and the material cover connector can connect to it. In other configurations, the strap can be made of the hook material portion of a hook and loop fastener with a loop material portion connection tab. The strap can include or omit a buckle that permits the strap to be passed through the buckle and doubled over onto itself to facilitate connection to the scope. The strap can be removable, or it (or one or more suitable connection portions for the material cover or material cover connector) can be mounted to the scope via an adhesive, mechanical fasteners, magnetic fasteners, or can even be integrated into the scope. It should be understood that the strap, if included, can serve as a connection point for the material cover connector.

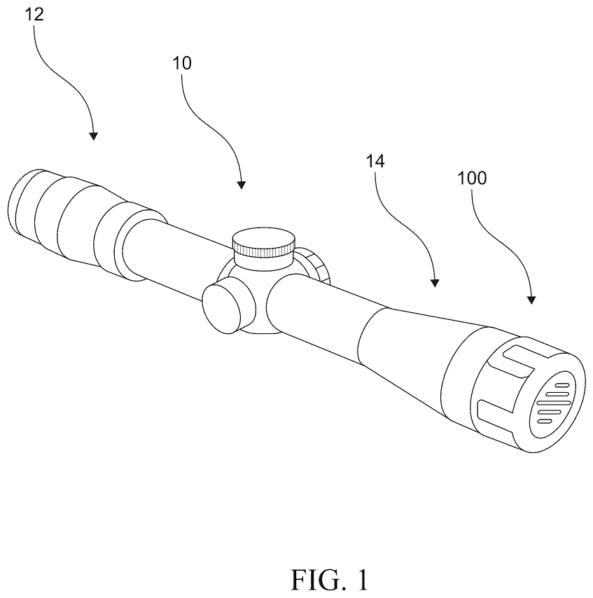

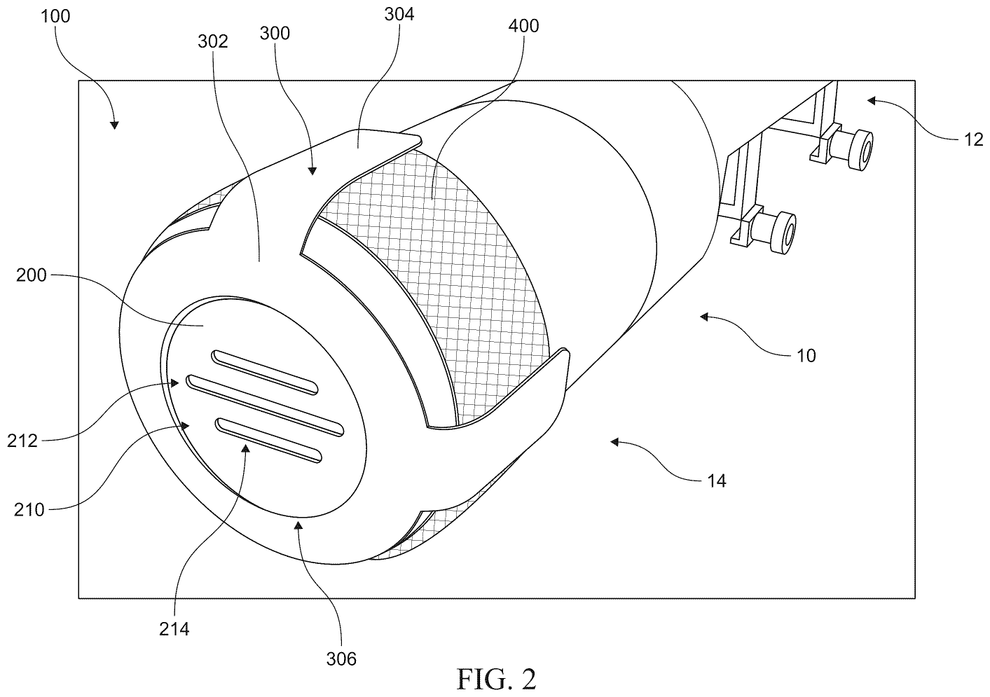

FIGS. 1-4 illustrate an embodiment of the anti-glare system 100, which includes a material cover 200, a material cover connector 300, and a strap 400. The anti-glare system 100 is mounted on a scope 10 for a firearm, such as a rifle (not shown). The scope 10 has a first end or a user end 12 and a second end or target end 14. The anti-glare system 100 is preferably mounted to the target end 14 of the scope 10. The material cover 200 of the anti-glare system 100 can comprise a plurality of slots 210, which can be located in a central region of the material cover 200. The plurality of slots 210 in the illustrated embodiment includes a first slot 212 located at or near a center of the material cover 200. The plurality of slots 210 further includes a second set of slots 214. The second slots 214 are located further from the center of the material cover 200 relative to the first slot 212.

In the illustrated embodiment, the material cover connector 300 comprises a circular ring 302 and a plurality of arms 304 spaced around and extending from the ring 302. In use, the arms 304 connect the material cover connector 300 and the material cover 200 to the strap 400. The material cover connector 300 further comprises a cut-out region 306, which allows at least a central portion of the material connector 200 to be exposed within the ring 302. The material cover 200 is connected to the material cover connector 300, such that the central portion of the material cover 200 fills a portion or an entirety of the cut-out region 306.

As described previously, one or more of the material cover 200, the material cover connector 300, and the strap 400 can include or be constructed of a hook material or a loop material of a hook and loop fastener. In the illustrated arrangement, a forward facing surface of the material cover 200 (relative to the scope 10—facing away from the scope) is or includes a loop material of a hook and loop fastener. A rearward facing surface of the material cover connector 300 (relative to the scope 10—facing towards the scope 10) is or includes a hook material of a hook and loop fastener. Accordingly, a peripheral portion of the material cover 200 can be coupled to the ring 302 of the material cover connector 300.

In the illustrated arrangement, a radially outward facing surface the strap 400 is or includes a loop material of a hook and loop fastener. The strap 400 may also include a hook material of a hook and loop fastener that allows an end portion of the strap 400 to be connected to itself to secure the strap 400 in a loop shape attached to the scope 10. In some configurations, one side (a radially outward facing side) of the strap 400 can be or include a loop material and the other side (a radially inward facing side) of the strap 400 can be or include a hook material. In some configurations, the radially inward facing side of the strap 400 can include a tab of a hook material. In other configurations, the entire radially inward facing side of the strap 400 can be a hook material. In use, the strap 400 wraps around a circumference of the second end 14 of the scope 10. The loop material of the radially outward facing surface of the strap 400 is configured to connect to the arms 304 of the material cover connector 300 and, thus, connect the material cover 200 to the scope 10.

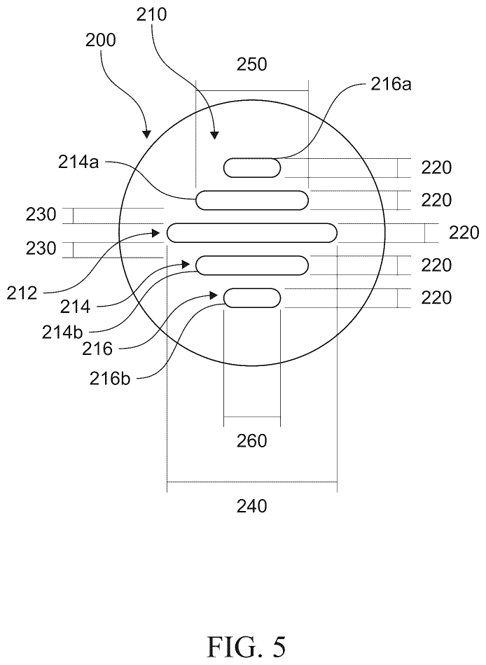

FIG. 5 illustrates an embodiment of the material cover 200. The illustrated material cover 200 is a circle with a diameter configured to be used with a scope 10 having a similar objective lens diameter. For example, the illustrated material cover 200 has a 50 mm diameter designed for a scope with a 50 mm objective lens diameter. The material cover 200 includes a plurality of slots 210. In the illustrated arrangement, the plurality of slots 210 comprises a first slot 212, a second set of slots 214, and a third set of slots 216. The first slot 212 is the longest slot and is located at or closest to the center of the material cover 200. The second set of slots 214 comprises two individual slots 214a, 214b. They are the same length in the illustrated embodiment, but they could also differ in length. The second slots 214a, 214b are shorter in length than the first slot 212 and are located further from the center, i.e., closer to the edge of the optic of the scope 10 in a direction perpendicular to length of the slots 214a, 214b, than the first slot 212. Similar to the second set of slots 214, the individual slots 216a, 216b of the third set of slots 216 are the same length in the illustrated embodiment, but they could also differ in length. The third slots 216a, 216b are shorter in length than the second slots 214a, 214b and are located further from the center, i.e., closer to the edge of the optic of the scope 10 in a direction perpendicular to length of the slots 216a, 216b, than the first slot 212 and the second slots 214.

In the illustrated embodiment, each of the plurality of slots 210 has a consistent height across its length, but it could also vary in height across its length. The plurality of slots 210 can be horizontal slots. Each of the plurality of slots 210 in the illustrated embodiment are 4 mm in height and the spacing between each of the plurality of slots 210 is 2 mm. The height and spacing could also vary between the plurality of slots 210. In some embodiments, the height 220 of each of the plurality of slots 210 can be between 3 mm and 5 mm, or 3.5 mm and 4.5 mm and the gap 230 between them can be between 1 mm and 3 mm, or 1.5 mm and 2.5 mm. The first slot 212 can have a length 240 of 32 mm, or between 28 mm and 36 mm, between 30 mm and 34 mm, or between 31 mm and 33 mm. The second slots 214a, 214b can have a length 250 of 21 mm, or between 18 mm and 24 mm, between 19 mm and 23 mm, or between 20 mm and 22 mm. The third slots 216a, 216b can have a length 260 of 11 mm, or between 8 mm and 14 mm, between 9 mm and 13 mm, or between 10 mm and 12 mm.

It should also be understood that the lengths, heights, or total combined area of the plurality of slots 210 can be described as a ratio of the slot to the size (e.g., diameter) or total area of either or both of the material cover 200 or the scope lens. For example, if the objective lens diameter of the scope 12 is 100 mm, the material cover 200 diameter can be 100 mm. In that case, the length of the first slot can be 64 mm, double the 32 mm illustrated in connection with the 50 mm diameter material cover 200. The ratio could also be based on other criteria such as area. The total area of the plurality of slots 210 in the illustrated embodiment accounts for 18.7% of the area of the material cover 200. The total area of the plurality of slots 210 can account for between 18% and 19%, 17% and 20%, or 16% and 20%. Other total areas of the plurality of slots 210 relative to the area of the material cover 200 can be used, which can be configured based on the desired performance characteristics. For example, the total area of the slots can be lower than 16% for very bright light environments or higher than 20% for lower light environments.

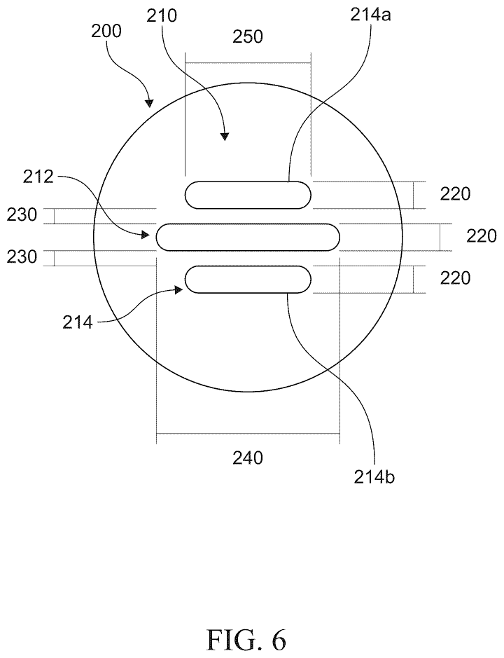

FIG. 6 illustrates another embodiment of the material cover 200. The material cover 200 in the illustrated arrangement is a circle with a 50 mm diameter designed for a scope with a 50 mm optic diameter. The material cover 200 comprises a plurality of slots 210. In the illustrated arrangement, the plurality of slots 210 comprises a first slot 212 and a second set of slots 214. The first slot 212 is the longest slot and is located at or closest to the center of the material cover 200. The second set of slots 214 includes two individual slots 214a, 214b. The slots 214a, 214b are the same length in the illustrated arrangement, but could be different lengths. The second slots 214a, 214b are shorter than the first slot 212 and are located further from the center, i.e., closer to the edge of the optic of the scope 10 in a direction perpendicular to the length of the slot 212, than the first slot 212.

In the illustrated embodiment, each of the plurality of slots 210 has a consistent height across its length, but it could also vary in height across its length. The plurality of slots 210 can be horizontal slots. The plurality of slots 210 in the illustrated embodiment are 5 mm in height and the spacing between slots 210 is 2 mm. In some embodiments, the height 220 of each of the plurality of slots 210 can be between 3 mm and 6 mm, 4 mm and 6 mm, or 4.5 mm and 5.5 mm and the gap 230 between them can be between 1 mm and 3 mm, or 1.5 mm and 2.5 mm. The first slot 212 can have a length 240 of 30 mm, or between 24 mm and 36 mm, between 28 mm and 32 mm, or between 29 mm and 31 mm. The second slots 214a, 214b can have a length 250 of 21 mm, or between 18 mm and 24 mm, between 19 mm and 23 mm, or between 20 mm and 22 mm. The plurality of slots 210 need not be a traditional slot. Rather, each of the plurality of slots 210 can be a rectangle with chamfered edges or filleted edges. They also can be ovals or other abnormal shapes. This applies to any of the slots disclosed herein.

It should also be understood that the lengths, heights, or total combined area of the plurality of slots 210 can be described as a ratio of the slot to the size (e.g., diameter) or total area of either or both of the material cover 200 or the scope lens. For example, if the objective lens diameter of the scope 12 is 100 mm, the material cover 200 diameter can be 100 mm. In that case, the length of the first slot can be 60 mm, double the 30 mm. Or can be double any of the other dimensions disclosed herein. The ratio could also be based on other criteria such as area. The total area of the plurality of slots 210 in the illustrated embodiment accounts for 17.5% of the area of the material cover 200. The total area of the slots can account for between 17% and 18%, 16% and 19%, or 16% and 20%. Other total areas of the plurality of slots 210 relative to the area of the material cover 200 can be used, which can be configured based on the desired performance characteristics.

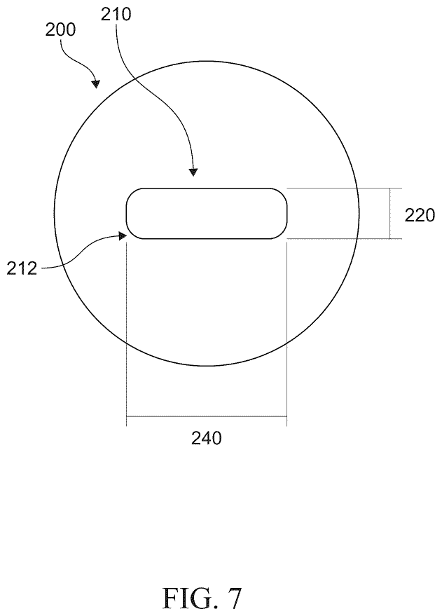

FIG. 7 illustrates yet another embodiment of the material cover 200. The illustrated material cover 200 is a circle with a 50 mm diameter designed for a scope 10 with a 50 mm objective lens diameter. The material cover 200 comprises at least one slot 210. In the illustrated arrangement, the at least one slot 210 comprises a single slot 212. A single larger slot 212 as shown can be well-suited or ideal for low light conditions.

In the illustrated arrangement, the slot 212 has a consistent height across its length, but it could vary in height across its length. The illustrated slot 212 is 9 mm in height. In some embodiments, the height 220 of the slot 212 can be between 7 mm and 11 mm, 8 mm and 10 mm, or 8.5 mm and 9.5 mm. The slot 212 can have a length 240 of 27 mm, between 22 mm and 32 mm, between 24 mm and 30 mm, or between 26 mm and 28 mm. It should also be understood that the slot 212 need not be a traditional slot, it can be a rectangle with chamfered edges or filleted edges as shown, or a traditional slot with a half circle at each end. The slot 212 also can be an oval or a different shape.

It should also be understood that the lengths, heights, and area of the slot 212, or other slots, can be described as a ratio of the slot to the size (e.g., diameter) or total area of either or both of the material cover 200 or the scope lens. For example, if the objective lens diameter of the scope 12 is 100 mm, the diameter of the material cover can be 100 mm. In that case, the length of the first slot can be 54 mm, double the 27 mm illustrated in connection with the 50 mm diameter material cover 200. The ratio could also be based on other criteria, such as area. The total area of the slot 212 in the illustrated embodiment accounts for 12.2% of the area of the material cover. The total area of the slot 212 can account for between 11% and 13%, 10% and 14%, or 9% and 15%. The total area of the single slot 212 design for low light can be less than that of a plurality of slots designed for daytime environmental light use. However, the height 220 of the single slot 212 is greater than the heights 220 of the slots 210 in the multi-slot embodiments.

In use, the strap 400 is wrapped around the circumference of the scope 10. The strap 400 serves as a mounting point for the material cover connector 300. The material cover 200 can be connected to a first side of the material cover connector 300. In the illustrated arrangement, an outer periphery of the material cover 200 is connected to the ring 302 of the material cover connector 300. The material cover connector 300 can be connected to the strap 400 via the arms 304. In particular, the first side of the arms 304 of the material cover connector 300 connects to the strap 400. In the illustrated arrangement, the material cover connector 300 includes four (4) arms 304. However, there could be a greater or lesser number of arms 304. Further, the material cover connector 300 can connect to the strap 400 or directly to the scope 10 via an alternative method.

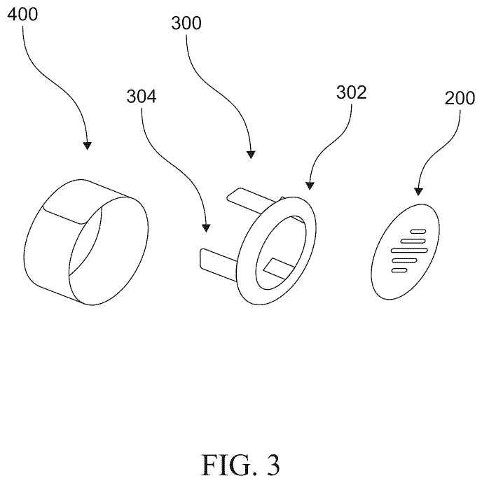

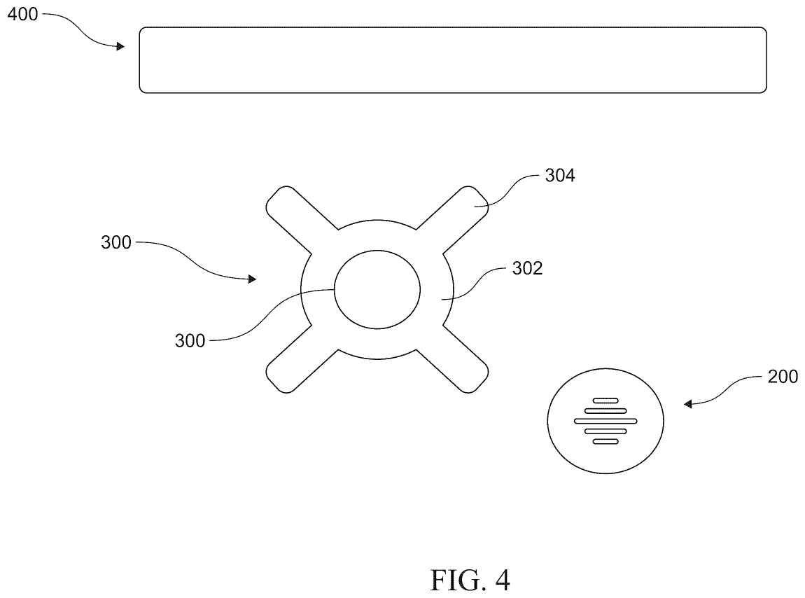

FIGS. 3 and 4 illustrate the components of the anti-glare system 100. The components of FIGS. 3 and 4 can represent a potential kit, which can include a variety of different material covers 200. Only one material cover 200 is shown in FIGS. 3 and 4; however, two or more of the material covers 200 of FIGS. 5-7 can be provided in the kit. It should be understood that because the material cover 200, the material cover connector 300, and the strap 400 are all made of a thin flexible material such as hook and loop fastener material, they can be easily stowed. Further, the anti-glare system 100 is modular, in that a user can swap out the specific material cover 200 depending on the light conditions. In some configurations, the strap 400 can remain in place while the user changes the material cover 200 for a different one by removing the material cover connector 300 from the strap 400.

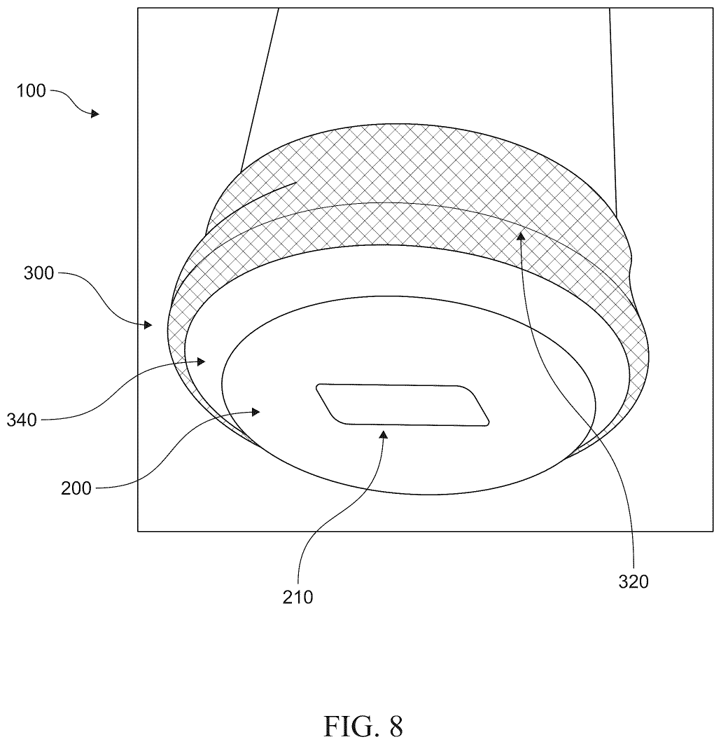

FIG. 8 illustrates an alternative embodiment of the anti-glare system 100. The anti-glare system 100 of FIG. 8 includes a material cover connector 300 that comprises an elastic portion 320 and a material cover connecting portion 340. The elastic portion 320 can be made of the same material as the material cover connecting portion 340 or a different material, as shown in the illustrated embodiment. The elastic portion 320 can be constructed from or include an elastic material that allows the material cover connector 300 to be secured by a constricting force caused by the elasticity of the material or an elastic retention member on an outside of the scope 10 in a location and manner similar to that of the strap 400. The elastic portion 320 is configured to automatically adjust to scopes of different diameter, at least within an acceptable range. The elastic portion 320 can constrict around a variety of scope diameters.

The material cover connecting portion 340 can be made of the loop material portion or the hook material portion of a hook and loop fastener and the material cover 200 can be made of the other of the loop material portion and the hook material portion. Although not shown, the material cover connecting portion 340 includes a cut-out region 306, which is configured to provide enough material to connect to a peripheral portion of the material cover 200, but not to obstruct the slot(s) 210. The material cover 200 can then be connected to the material cover connecting portion 340, such that the material cover 200 covers or substantially covers the cut-out region of the material cover connecting portion 340. In the illustrated arrangement, the material cover 200 of FIG. 7 is attached to the material cover connector 300. However, any of the available material covers 200 can be connected to the material cover connector 300.

It should be understood that the components described in this disclosure can be used outside of scopes. The components described can be applicable in the reduction or elimination of glare or reflection in the context of any optic.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present hydrant valve has been described in the context of particularly preferred embodiments, the skilled artisan will appreciate, in view of the present disclosure, that certain advantages, features and aspects of the mechanism and overall system can be realized in a variety of other applications, many of which have been noted above. Additionally, it is contemplated that various aspects and features of the invention described can be practiced separately, combined together, or substituted for one another, and that a variety of combination and sub combinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. An anti-glare system, the anti-glare system comprising:
a material cover comprising at least one slot; and
an attachment mechanism configured to attach the material cover to an scope;
wherein the material cover is less than 3 mm thick.

2. The anti-glare system of claim 1, wherein the at least one slot is a horizontal slot and a height of the at least one slot is consistent or varies along a width of the at least one slot.

3. The anti-glare system of claim 1, wherein the at least one slot comprises:
a first pair of slots;
a second pair of slots, wherein individual slots of the second pair of slots are larger than individual slots of the first pair of slots;
and a third slot, wherein the third slot is larger than individual slots of the second pair of slots.

4. The anti-glare system of claim 3, wherein a height of the individual slot of the first pair of slots, an individual slot of the second pair of slots, or the third slots is between 3 mm and 5 mm.

5. The anti-glare system of claim 1, wherein the at least one slot comprises:
a first pair of slots;
a second slot, wherein the second slot is larger than individual slots of the first pair of slots.

6. The anti-glare system of claim 5, wherein a height of the individual slot of the first pair of slots or an individual slot of the second pair of slots is between 4 mm and 6 mm.

7. The anti-glare system of claim 1, wherein the at least one slot comprises a plurality of slots, and where an area of the plurality of slots is between 16% and 20% of an area of an optic of the scope.

8. The anti-glare system of claim 1, wherein the at least one slot is defined by a single slot, and where an area of the single slot is between 10% and 14% of an area of an optic of the scope.

9. The anti-glare system of claim 1, wherein the at least one slot is entirely defined by a single slot and a height of the single slots is between 8 mm and 10 mm.

10. The anti-glare system of claim 1, wherein an individual slot of the at least one slot is distanced between 1.5 mm and 2.5 mm from another individual slot of the at least one slot.

11. An anti-glare system, the anti-glare system comprising:
a strap configured to wrap circumferentially around a scope;
a material cover; and
a material cover connector, wherein the material cover connector is configured to connect the material cover to the strap.

12. The anti-glare system of claim 11, wherein the strap is made of hook and loop material.

13. The anti-glare system of claim 11, wherein the material cover is made of hook and loop material.

14. The anti-glare system of claim 11, wherein the material cover connector is made of hook and loop material.

15. The anti-glare system of claim 11, wherein the material cover comprises at least one slot.

16. The anti-glare system of claim 11, wherein the material cover connector comprise a plurality of arms configure to connect the material cover connector to the strap.

17. The anti-glare system of claim 11, wherein the material cover connector comprises a hole and wherein the material cover is configured to cover at least a portion of the hole.

18. The anti-glare system of claim 11, wherein the material cover is less than 3 mm thick.

19. An anti-glare system, the anti-glare system comprising:
a material cover; and
a material cover connector, wherein the material cover connector comprises an elastic portion configured to secure the material cover connector to a scope;
wherein the material cover is configured to connect to the material cover connector.

20. The anti-glare system of claim 19, wherein the material cover comprises at least one slot.
